(19) United States
(12) Patent Application Publication
(10) Pub. No.: US 2007/0143702 A1
(43) Pub. Date: Jun. 21, 2007

(54) Method, Computer Program, and System Improving the Graphical User Interface of a Desktop

(76) Inventor: Fabio Maggi, Rome (IT)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/611,921

(22) Filed: Dec. 18, 2006

(30) Foreign Application Priority Data
Dec. 21, 2005 (EP) 05112638.1

(51) Int. Cl. G06F 17/00

(52) U.S. Cl. 715/779

(57) ABSTRACT

A method for managing application instance windows on a window based desktop, includes the steps of receiving a request to associate a logical group to an application instance; displaying a window for asking the user to associate a name of the application instance to a project name; and providing to the operating system graphical user interface a visualization characteristic identifying the associated project of the icon displayed on the desktop when the application instance is minimized. The user is requested to choose the visualization characteristic identifying the project name to which the Application Instance belongs to. The visualization characteristic is provided to the Operating System GUI for display of the Application Instance icon.

### FIELD OF THE INVENTION

The present invention generally relates to graphical user interface and, more particularly, to a method and system to improve the active task window management in the desktop view.

### BACKGROUND OF THE INVENTION

On a workstation, the graphical user interface used for displaying the desktop view depends on the Operating System. Most of the Operating Systems have a windows based desktop to graphically manage windows of active tasks. The options of the operating system for displaying in the desktop the icons of the active tasks influence the user ability to organize his work on the workstation. By clicking on icons, the user interacts with several applications or with more than one instance of the same application at the same time. When the user wants to minimize an active window an icon representing this minimized is displayed on a task bar. To each icon are associated some information on the minimized window in a way which makes this visualization not satisfying for a good operability of the different active tasks on the task bar. For instance, under the active task icon the application type and name may be displayed which is not very helpful for an efficient manipulation.

The Japanese patent application assigned to Casio Comput CO Ltd. and published under the number 05061632, describes a solution for identifying in a very friendly way the most used tasks by changing the display size of the icon of the active tasks in accordance with the selecting frequency of a menu item. The most used tasks are quickly visually identified. However, this improvement does not help the user to organize his work when, for instance he manages more than one project grouping a set of active tasks. How can he quickly navigate easily between his different projects or activities? A manager may use his laptop for three different activities, such as
1) organizing his team hardware asset,
2) preparing his team vacation plan,
3) reviewing some documentation related to the project he is involved in.

Any of these activities involve the usage of different software applications and, in some cases, different instances of the same application.
1) Involves: 1 web browser page with the details of his team hardware asset, 1 web browser page with the description of the components (memory, processor, disk capacity) of the items of the hardware assets, 1 worksheet with the list of the brand new workstations to be assigned to teammates.
2) Involves: 1 worksheet with the calendar of team members' vacation, 1 text document with workers assignment for the actual project.
3) Involves: 1 text document for the project design document, 1 text document for the marketing requirements, and 1 web browser page with the product official documentation to be reviewed.

In this easy example the manager has 3 web browser pages, 2 worksheets, and 3 text documents reduced to icon in the taskbar which are indistinguishable as they are displayed unless they are completely reopened. The corresponding icons appear uniformly on the desktop. If, applying the Japanese patent, the most frequently windows have the greatest size, this does not help distinguishing between all the activities.

Certain operating systems have already implemented an improved visualization of the taskbar for a better work organization of the user. For instance, Common Desktop Environment (CDE) is a graphical user interface that serves as the default desktop in IBM AIX systems. CDE allows you to open multiple desktops in a highly reliable and stable environment. Each desktop can then run multiple independent applications dedicated to a specific activity without interfering with the operations of the other three. This is an ideal solution with such an operating system and companies having distributed workstations executing fixed centralized set of applications which need to be separated such as ordering, communication with remote sites and Internet connexions. This solution cannot be used over heterogeneous Operation System workstations of a company where the employees may have different activities or projects to work on in parallel and want to have the complete and direct control of all the items of the activities without any switching of desktop.

### SUMMARY OF THE INVENTION

It is therefore an object of the present invention to help the user to improve task icon manipulation displayed on the desktop of a workstation in which the Operating System has a window based desktop environment.

The object is achieved, as claimed in claim 1 with a method for managing application instance windows on a window based desktop, said method comprising the steps of:
receiving a request to associate a logical group to an application instance;
displaying a window for asking the user to associate a name of the application instance to a project name;
providing to the operating system graphical user interface a visualization characteristic identifying the associated project of the icon displayed on the desktop when the application instance is minimized.

The user is requested to choose the visualization characteristic identifying the project name to which the Application Instance belongs to, The visualization characteristic is provided to the Operating System GUI for display of the Application Instance icon.

The object of the invention is also achieved with a computer program product comprising programming code instructions for executing the steps of the method according to anyone of claims 1 to 11 when said program is executed on a computer.

The object of the invention is also achieved with system comprising means adapted for carrying out the method according to anyone of claims 1 to 11.

The method and system of the invention can be implemented with any type of Operating Systems having a window based desktop environment.

It allows identification of active tasks in different activity or project the user is working on. All is displayed in one screen which makes this visualization very accessible and quick to use.

### BRIEF DESCRIPTION OF THE DRAWINGS

FIG. 1 illustrates the new desktop view according to the preferred embodiment;

FIG. 2 describes the different software components of a workstation implementing the new desktop of the preferred embodiment;

FIG. 3 is the general flowchart of the method of managing visualization of application instances on a window based desktop according to the preferred embodiment;

FIG. 4 is a table used by the Application Switchboard for storing the information concerning the logical grouping of Application Instances according to the preferred embodiment;

FIG. 5 is a detailed view of the window of the Application Switchboard according to the preferred embodiment;

FIG. 6 is a detailed view of the Application Switchboard window for modifying Logical groups.

### DETAILED DESCRIPTION OF THE PREFERRED EMBODIMENT

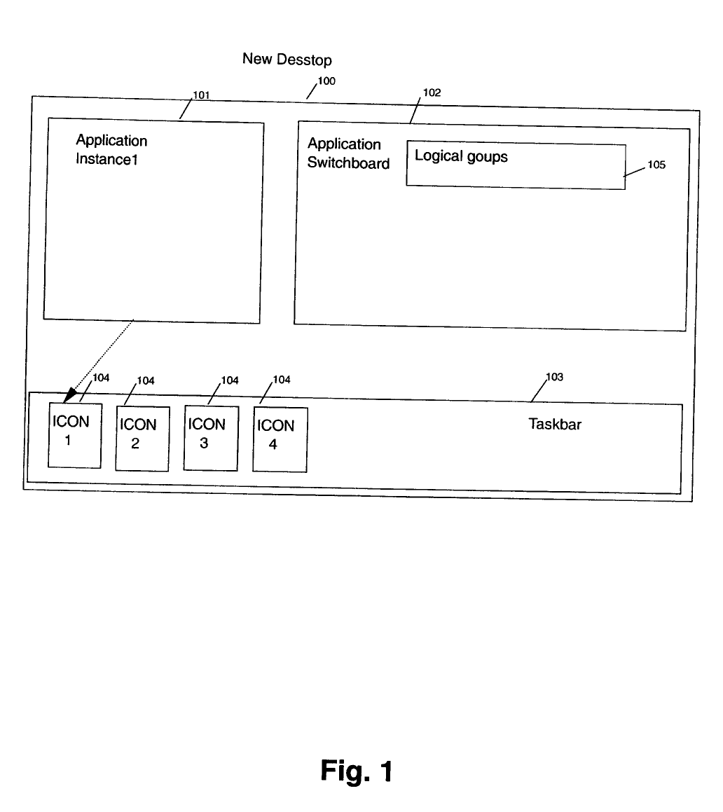

FIG. 1 illustrates the new desktop view according to the preferred embodiment. The window based desktop view (100) is controlled by the Graphical User Interface environment of the Operating System of the workstation. Each time the user starts a window based application, it becomes an active task which is visualized by the GUI of the operating system as a window in a desktop whereon are visualized all the active tasks. The user can reduced the size of the window to an icon while the task is still active and recall the window by clicking on the icon. The user can start one other application or the same application for which the window can be also reduced while they are active. Using the object-oriented technology vocabulary, the desktop view of the prior art is a container of window based Application Instances (101), a taskbar (103) and Application Icons (104). The desktop view of the preferred embodiment contains, in addition, a window based Application Switchboard (102) displaying a view of Application Logical groups (105). With the new desktop, according to the preferred embodiment, the information going along with the icons and more precisely in the preferred embodiment, the visualization attributes, have changed.

With the window based desktop views of the prior art, each Application Instance window (101) can be reduced to an icon (102) in the taskbar (103). When the user needs to use the Graphical User Interface of an Application Instance view which has been reduced to an icon, he simply clicks on the icon with the cursor and the corresponding Application Instance window (101) is displayed again. With the solution of the preferred embodiment, the user can further manage the Application Icons in the taskbar (103) and the Application Instances (101) from the Application Switchboard window.

From the Application Switchboard window, the user can activate operations such as creating application Logical Groups of Application instances belonging to a same activity or project. In the Logical Group view (105), the user can manipulate the icons, he can maximize them (104) associate some of them in a same Logical group (105), change icon linkage from one Logical group (105) to another one, or assign a same visualization attribute to icons (104) of the same logical group (105). In the taskbar of the desktop of the preferred embodiment, the icons (104) belonging to the same logical group (105) can be trivially identified. In the view of Application Logical groups (105) are visualized the associations between the application instances (101) belonging to the same activity and the application icons (104).

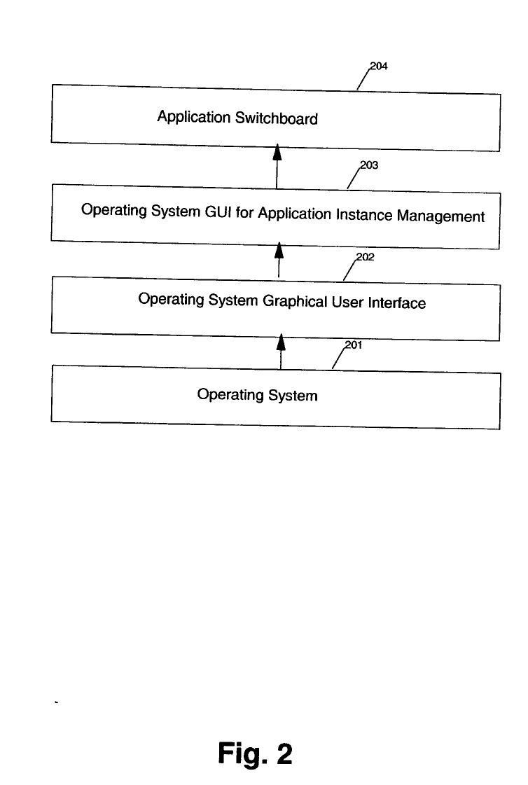

FIG. 2 describes the different software components of a workstation implementing the new desktop of the preferred embodiment. The software layers involved in this invention are the Operating System (201), the Operating System Graphical User Interface (202), the Operating System GUI Management System for the active application instances (203) and the Application Switchboard (204).

The operating system (201) is window based and operates on the workstation on which the method of the preferred embodiment is implemented. The Operating System GUI (202) is the layer responsible for the application window visualization, that is visualization of the active application instances created when the user starts an application on the workstation. The GUI Management System for the application instances (203) deals with application instances and icons manipulations. In the prior art, this layer implements the process for reducing the window of Application Instances to icons.

The Application Switchboard (204) is a brand new software component for Application Instance window management. This layer is responsible for improving the operability of the task icon manipulation and, for this reason, it is linked to the GUI Management System for the active application instances (203) provided by the Operating System (201). The Application Switchboard (204) must share Graphical User Interface Management System for the active application instances (203) libraries in order to manage successfully application icons. This link allows common icon management tasks provided by Graphical User Interface Management System for the active application instances (203) plus the operability improvement tasks defined for the Application Switchboard (204) from the same interface. The Application Switchboard interacts with Operating Systems GUI in different ways: first it is viewable from Operating System GUI, so it needs to be built according to Operating System libraries and interfaces; secondly it allows icons manipulations, which will be shown in a different and more operable way on the Operation System GUI itself. New code must be developed in order to create Application Switchboard layer (204), it could be implemented in any programming language, but preferably it should be developed in Java (RTM) in order to be used on any Operating Systems (201) without structural development differences. Java usage allows Application Switchboard (204) communication with others software layers with the only constraints of running a Java Virtual Machine on the Operating System (201) and programming appropriate Java calls in the Application Switchboard Layer (204) code to Operating System Graphical User Interface (202) and Graphical User Interface Management System for the active application instances (203).

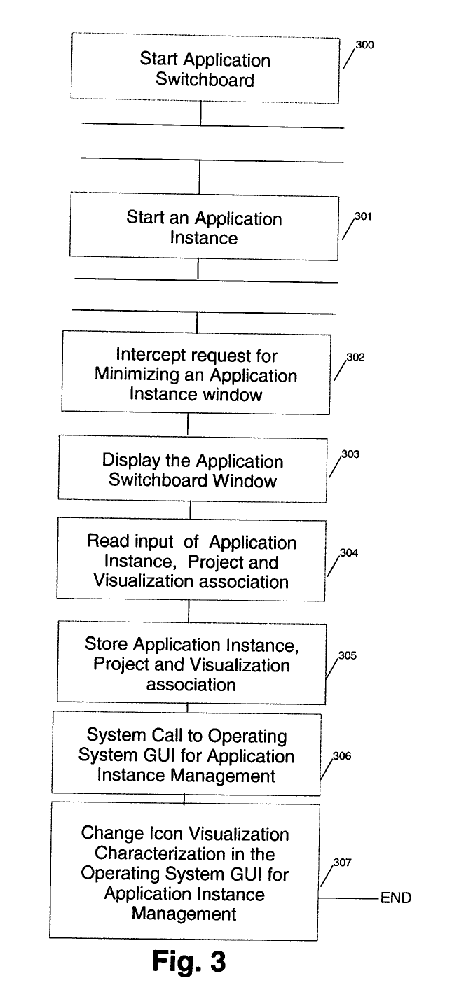

FIG. 3 is the general flowchart of the method of managing visualization of window based application instances on a desktop according to the preferred embodiment. The first step of the method consists in starting (300) the Application Switchboard. The way the user can plane for starting the application is described later in the document in reference to the same figure in the paragraph describing the possible use of the Application Switchboard in the environment of the workstation user.

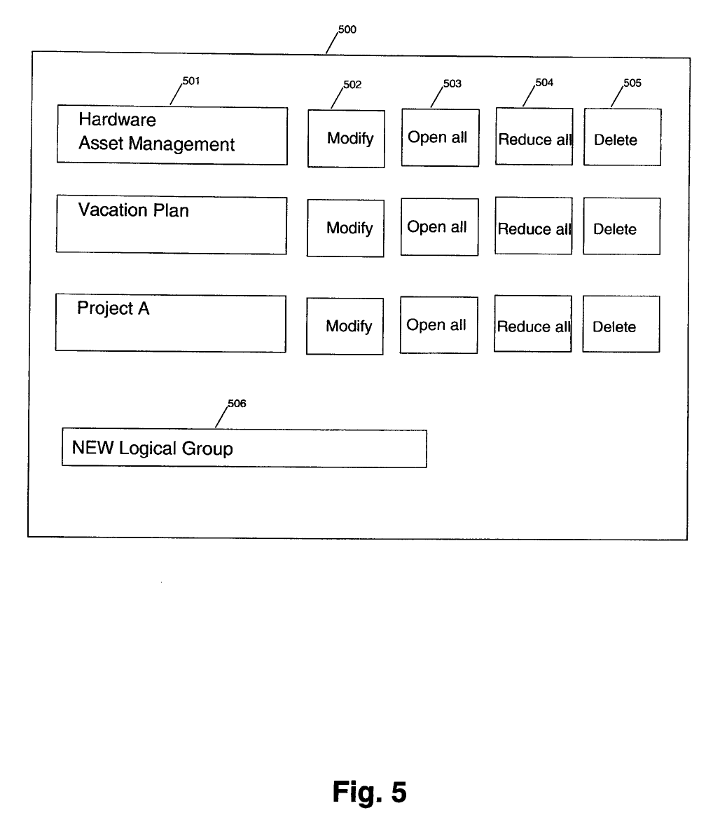

An Application Instance is created (301), then in the preferred embodiment, at any time, when the user reduces the size of the Application Instance window, the active Application Switchboard intercepts (302) the request of the user to the operating system GUI for application instance management for minimizing an Application Instance window. The Application Switchboard is itself window based. The Application Switchboard intercepting the request of the user which is active, by-passing the Operating System GUI Application Instance Management, displays (303) a window. One example of window is provided later in the document in reference with the description of FIG. 5. The user is requested (304) to enter through the Application Switchboard window the application instance name and the Logical group name he will give to a project encompassing this Application Instance and other ones during his session on the workstation.

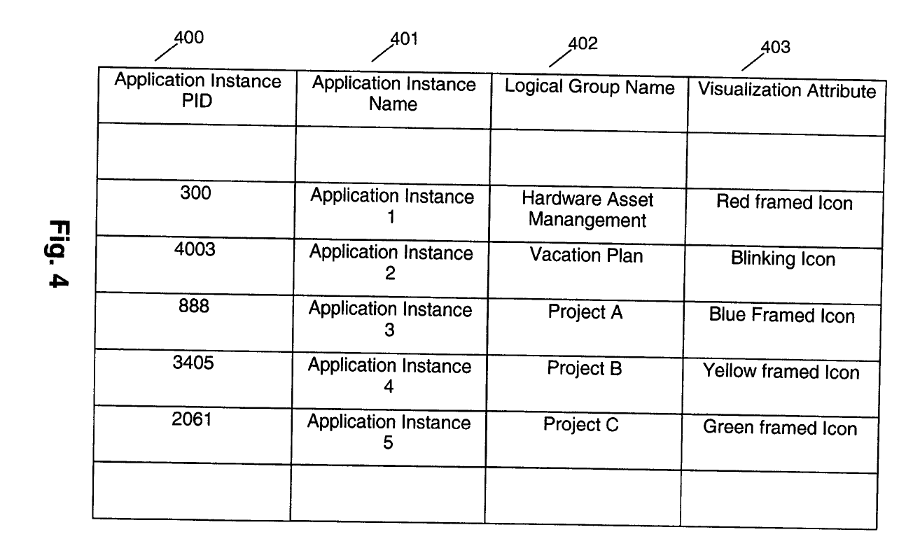

If this is the first Application Instance of the group that the user has decided to reduce to an icon, the user is requested to enter a new group name and a visualization characteristic which will be applied to the icon of all the application instances of the group when they will be reduced. The Application Switchboard preferably stores (305) this information in a table for which an example is illustrated later in the document in reference to the description of FIG. 4. The Application Switchboard provides (306) the Application Instance icon visualization characteristic as a parameter to the Operating System GUI Application Instance Management and gives the hand to the Operating System GUI Application Instance Management (307) which will consequently display the Application Instance icon with a visualization characteristic as entered by the user in the Switching Board window.

When the user decides to reduce to an icon a second Application Instance, the Application Switchboard window is displayed. The list of existing Logical group names with their visualization characteristic and associated Application Instance names can be read from the table and displayed on the window of the Application Switchboard. The user can either enter a new group name or select one of the displayed Logical group name and in this case will not have to enter visualization characteristic. The Application Switchboard updates the table accordingly.

When the user closes the an Application Instance, this event is detected by the Application Switchboard and the information concerning this Application Instance is canceled in the table. When all the Application Instance belonging to a same Logical group have been all closed, there is no more reference to the corresponding Logical group information including its visualization characteristic.

The Application Switchboard interfaces the Operating System GUI for Application Instance icon management using the Process Identifier defined by the Operating System for identifying an Application Instance. In the preferred embodiment, the Application Switchboard interfaces the Operating System GUI for Application Instance management for intercepting events such as:
the user reduces the window of an active Application instance and,
the user closes the window of an Application Instance.

The Application Switchboard interfaces also the Operating System GUI for Application Instance management for providing it, before display of the Application Instance icon, the visualization characteristic corresponding to the Logical group the Application Instance belongs to as defined by the user.

It is also noted that there are many embodiments of the invention the Application Switchboard can open a window automatically when it intercepts an event such as ‘a user reduces an application instance to an icon’. Or, the Application Switchboard can open a window automatically when it intercepts an event such as ‘an active task, which can be a task of the operating system, reduces an application instance to an icon’. Other embodiment consists in considering that the Application Switchboard window is opened at the request of the user. In this case the user may decide to let one Application Instance he starts be entirely managed by the Operating System GUI Application Instance management system. The user may decide for other Application Instances he starts which are part of different projects, to group them through the window of the Application Switchboard to group them by logical groups in order to improve manipulation of the icons. These possible embodiments may be combined.

One embodiment to be cited is the case where a visualization characteristic is not entered by the user through the Application Switchboard window. In this case the Application Switchboard can assign a default visualization characteristic to each new Logical group entered by the user. For instance the Application Switchboard can provide a succession of different color attributes each of them being used to display the Application Instance icons of a same group.

This paragraph describes a possible use of the Application Switchboard in the environment of the workstation user. According to the preferred embodiment, the Application Switchboard is implemented as a Java Application installed on the workstation Operating System and is available through the Operating System Graphical User Interface. Once the user logon on its workstation, he can use the application instances according to the workstation Operating System in use and he can manipulate Application Systems icons through Graphical User Interface Management System for the active application instances. Using the GUI Management System provided facilities, the workstation user can reduce to icon active application instances in the desktop taskbar, but, as discussed earlier in the document this operation can hide important information about the application instances themselves. At system logon user can run the Java Application of the preferred embodiment, but a possible variation could be the automatic startup of the same application at Operating System boot. The user has to open this Java Application GUI (a sort of Application Switchboard) which interacts with and controls Application Instances appearance on the Operating System GUI. Once the user decides to use an application instance, he can associate it to a Logical Group defined in the Application Switchboard through a window of the Java Application GUI. A good way to use this Java Application is to create Logical Group as soon as the first Application instance related to a user activity becomes active. In this case, the workstation user has to open the Java Application GUI, create an item related to the user activity and associate the just opened application instance to this Logical Group. A possible variation could be: create Logical Groups when Operating System GUI is already populated by many active application instances and, after that, associate every active application instances to related Logical Group item in the Application Switchboard. Peculiar properties are set in order to discriminate Logical Groups from Java Application GUI: in the preferred embodiment a different color can be associated to every Logical Group. A possible variation on peculiar property for Logical Group can be a unique texture for every application instance of the same Logical Group. Several management tasks can be performed from Java Application GUI (Application Switchboard): add or remove logical groups, add or remove application instances from Logical Group, modify Logical Group peculiar properties. The operability improvement in active application instances management comes from Logical Group peculiar properties: in a variation of the preferred embodiment a color is associated to every application instance of the same logical group, allowing discriminating application icons in the Operating System GUI. Once association between logical groups and application instances is set, workstation user can easily recall application instances related to its activity (logical group) without time loss in searching the right one. Another operability improvement is done via Java Application GUI (Application Switchboard) itself: all the Application Instances related to the same logical group can be maximized or minimized to icon simultaneously. According to that, workstation user interested in having available all the information related to an activity (Logical Group) has only to select the button from the Java Application GUI (Application Switchboard). At the end of the daytime work, association between application instances and logical group can be maintained, remaining available until specific management tasks are issued from Java Application GUI (Application Switchboard) itself.

FIG. 4 is a table used by the Application Switchboard for storing the information concerning the logical grouping of Application Instances according to the preferred embodiment. This table is created and used by the Application Switchboard when a name of a first application instance is entered by the user in the Application Switchboard window. The table is filled with the inputs entered by the user which comprise the Application Instance Process identifier (PID) (400), a unique integer number, set by the Operating System, which is associated to an application instance. The association between Application instance and PID cannot be modified by the user and remain until the Application Instance is closed. The Application Instance name (401) that the user are entered is also stored in the table. The Application Instance name is used by the Application Switchboard to interface the user through the GUI and the PID is used to interface the OS GUI. The Logical group name (402) also stored in the table is entered by the user and used by the Application Switchboard to interface the user. The visualization attribute (403) stored in the table is entered by the user. The Application switchboard converts this information into parameters to be given to the Operating System GUI Application Instance Management System.

Visualization Attribute Operating system GUI and Operating System GUI for Application Instance management do not allow customization of Application Instance icon visualization in order to identify in an efficient way the group the corresponding Application instances belong to. According to the preferred embodiment, a method is proposed to group Application Instances belonging to the same user activity and to identify them with a visualization characteristic in the Operating System GUI. There could be different implementations about icon visualization improvement according to the belonged group. It is noted that the different visualization characteristic distinguishing the Application Instances of a same group depends on the capabilities of the Operating System GUI as in the preferred embodiment, the Application Switchboard relies on the Operating System GUI.

The most common visualization characteristic is the color attribute this is commonly used by all the OS GUI: once a group is associated to a color, any Application Instance reduced to an icon will be displayed with this particular color and will be immediately associated by the user to the other icons of the same color in the Operating System GUI. Another possibility is to have the Application Instances group name (which was previously set from the Application Switchboard) displayed in the taskbar near to the Application Instance name. Another possibility is the Application Instances group associated with a font: the Application Instances icon will show its name with a different font according to the belonging group. Another possibility is the blinking frequency for icons: a different frequency according to the selected group could be helpful to discriminate Application Instances belonging to different groups. Another possibility can be the visualization of an image instead of the Application Instance name while it is reduced to icon, this image should recall the user activity immediately in order to discriminate them. Finally, any combination of the previous examples could be a good visualization characteristic: for example, having Application Instances icons divided by color and with the Application Instance name displayed with a particular font seems a powerful way to improve operability.

FIG. 5 is a detailed view of the window of the Application Switchboard according to the preferred embodiment. In the preferred embodiment the Application Switchboard GUI (500) is shown as a window from which management task on application icons can be performed. A list of Logical Groups can be shown (501) from it and every item of this list is related to a user activity, these are univocally distinguishable by their name or other properties set using button (502). The items of the list can be added by a button (506) or deleted by another button (505) on the Application Switchboard window (500). Tasks such as adding Application instances icon to a Logical Group (501) or particular tasks to improve icon management operability can be performed from a button (502). A useful operation such as maximize or reduce all the icons related to the same activity (which are grouped under the same Logical Group (501)) can be performed from button (503) and (504) in the preferred embodiment.

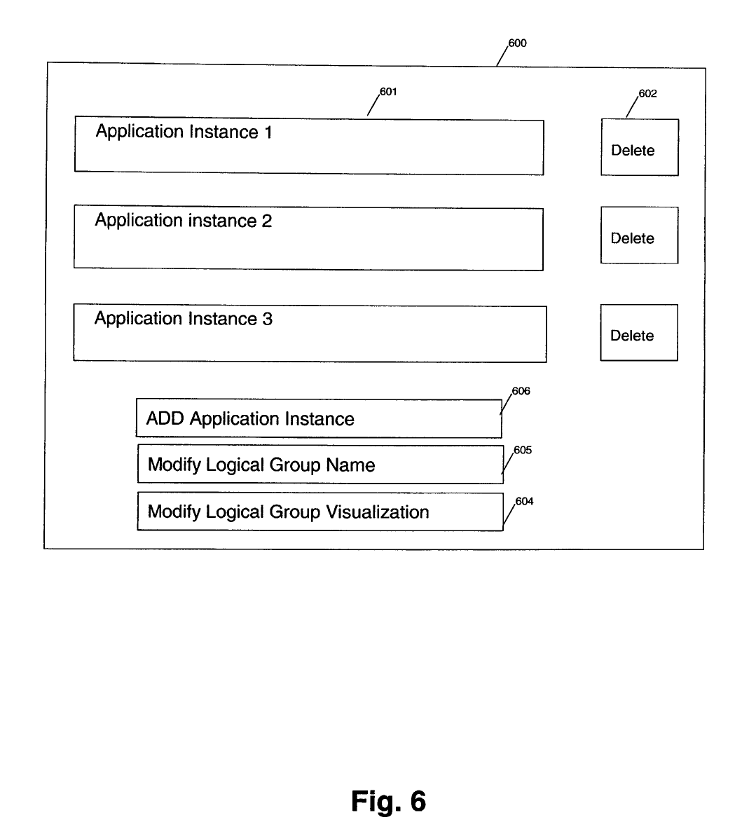

FIG. 6 is a detailed view of the Application Switchboard window for modifying Logical groups. In the preferred embodiment, the Application Switchboard window shows a button (502) to modify Logical Groups defined in it. A new panel for Modifying Logical Group (600) will open using button (502) and from this panel (600) management operation on application instances can be performed. A list of Application Instances can be shown (601) from it and every item of this list is related to an active application icon in the Operating System GUI. The items of the list can be added by a button (606) or deleted by another button (602) on the Modifying Logical Group Panel (600). The buttons (605) and (604) are used for Logical Group customization, allowing operability improvement in the task icon manipulation by setting a particular color and name to any icon of the same Logical Group.

1. A method for managing application instance windows on a window based desktop said method comprising the steps of:
receiving a request to associate a logical group to an application instance
displaying a window for asking the user to associate a name of the application instance to a project name;
providing to the operating system graphical user interface a visualization characteristic identifying the associated project of the icon displayed on the desktop when the application instance is minimized.

2. The method of claim 1 wherein the receiving step comprises:
receiving from the user through the operating system graphical user interface a request for displaying a window.

3. The method of claim 1 wherein the receiving step comprises:
intercepting a request to the operating system graphical user interface to start an application instance.

4. The method of claim 1 wherein the receiving step comprises:
intercepting a request by the user to the operating system graphical user interface to minimize an application instance for the first time.

5. The method of claim 1 wherein the receiving step comprises:
intercepting a request by an active task to the operating system graphical user interface to minimize an application instance for the first time.

6. The method of claim 1 wherein the displaying step further comprises:
asking the user to enter a visualization characteristic for the associated project; and the providing step further comprises:
using the visualization characteristic entered by the user to provide it to the operating system graphical user interface.

7. The method of claim 1 further comprising:
storing in a storage means the application instance name, the associated project name and the visualization characteristic of the associated project name.

8. The method of claim 7 further comprising:
each time a request to associate a logical group to an application instance is received, if the application instance name information is retrieved in the table, retrieving in the storage means the project name and the visualization characteristic and executing the providing step while skipping the step of displaying a window for asking the user to associate a name of the application instance to a project name.

9. The method of claim 7 further comprising:
each time a request to associate a logical group to an application instance is received, if the application instance name information is not retrieved in the table, displaying in the displayed window for asking the user to associate a name of the application instance to a project name, the list of all the application instance names and associated project names read in the storage means, and, asking the user to associate a new project name or to designate an existing project name.

10. The method of claim 7 further comprising:
storing in the storage means the application instance process identifier associated to the application instance name used for interfacing the operating system graphical user interface.

11. The method of claim 7 further comprising:
intercepting the ending of an application instance and suppressing the corresponding application instance information in the storage means.

12. A computer-usable medium embodying computer program code, the computer program code comprising computer executable instructions configured for:
receiving a request to associate a logical group to an application instance;
displaying a window for asking the user to associate a name of the application instance to a project name;
providing to the operating system graphical user interface a visualization characteristic identifying the associated project of the icon displayed on the desktop when the application instance is minimized.

13. The computer-usable medium of claim 12, wherein the embodied computer program code further comprises computer executable instructions configured for:
receiving from the user through the operating system graphical user interface a request for displaying a window.

14. The computer-usable medium of claim 12, wherein the embodied computer program code further comprises computer executable instructions configured for:
intercepting a request to the operating system graphical user interface to start an application instance.

15. The computer-usable medium of claim 12, wherein the embodied computer program code further comprises computer executable instructions configured for:
intercepting a request by the user to the operating system graphical user interface to minimize an application instance for the first time.

16. The computer-usable medium of claim 12, wherein the embodied computer program code further comprises computer executable instructions configured for:
intercepting a request by an active task to the operating system graphical user interface to minimize an application instance for the first time.

17. The computer-usable medium of claim 12, wherein the embodied computer program code further comprises computer executable instructions configured for:
asking the user to enter a visualization characteristic for the associated project; and
using the visualization characteristic entered by the user to provide it to the operating system graphical user interface.

18. The computer-usable medium of claim 12, wherein the embodied computer program code further comprises computer executable instructions configured for:
storing in a storage means the application instance name, the associated project name and the visualization characteristic of the associated project name.

19. The computer-usable medium of claim 18 wherein the embodied computer program code further comprises computer executable instructions configured for:
each time a request to associate a logical group to an application instance is received, if the application instance name information is retrieved in the table, retrieving in the storage means the project name and the visualization characteristic and executing the providing step while skipping the step of displaying a window for asking the user to associate a name of the application instance to a project name.

20. The computer-usable medium of claim 12, wherein the embodied computer program code further comprises computer executable instructions configured for:
each time a request to associate a logical group to an application instance is received, if the application instance name information is not retrieved in the table, displaying in the displayed window for asking the user to associate a name of the application instance to a project name, the list of all the application instance names and associated project names read in the storage means, and, asking the user to associate a new project name or to designate an existing project name.
